(19) United States
(12) Patent Application Publication
(10) Pub. No.: US 2017/0190147 A1
(43) Pub. Date: Jul. 6, 2017

(54) Fire Resistant Building Boards with Increased Amounts of Anti-Shrinkage Additives and Decreased Densities

(71) Applicant: Saint-Gobain Placo SAS, Suresnes (FR)

(72) Inventors: Laura Brooks, Loughborough (GB); Pamela Shinkoda, Oakville, CA (US); Bemard Bouteiller, Cavaillon (FR); Julien Seller, Aubervilliers Cedex (FR)

(21) Appl. No.: 14/986,237

(22) Filed: Dec. 31, 2015

(51) Int. Cl. B32B 13/08; B32B 13/02; E04B 1/94

(52) U.S. Cl. CPC B32B 13/08; E04B 1/942; B32B 13/02; B32B 2262/101; B32B 2264/102; B32B 2607/00

(57) ABSTRACT

Disclosed is a building board with increased heat and fire resistance. Boards constructed in accordance with this disclosure have lower densities while at the same time containing larger amounts of anti-shrinkage materials. In one embodiment, a board was constructed with a density of less than 1,750 lbs/msf while at the same time including anti-shrinkage additives in amounts greater than 14% by weight of the core material. The inventors have discovered that beneficial, and heretofore unexpected, levels of fire resistance can be achieved by using increased amounts of anti-shrinkage additives in lower density building boards.

### TECHNICAL FIELD

This disclosure relates to a fire resistant building board. More particularly, the present disclosure relates to the use of increased volumes of anti-shrinkage additives in low density boards to achieved improved levels of fire resistance and dimensional stability.

### BACKGROUND OF THE INVENTION

Building board, such a plasterboard, drywall or gypsum board, is a commonly used building component. It is typically used as an interior room partition, but it can also be used in ceilings. The basic construction includes two exterior paper faces and an intermediate core of gypsum plaster. The plaster can be mixed with various additives to increase the performance of the resulting building board. These additives include starches and fiberglass.

Building boards have several key advantages over prior construction techniques, such a lath and plaster. Building boards, for instance, are lightweight and can be easily installed and positioned. They also present an excellent finishing surface and good sound control. Building board is also fire resistant and has the ability to stop fire propagation between rooms. This is because the gypsum contains crystalized water that releases when heated.

Additives can be included within the gypsum core to enhance the natural fire resistance of the board. These boards are referred to a fire rated or “Type X” drywall. Known additives include glass fibers and anti-shrinkage materials. Board integrity is an important factor in fire resistance. When heated, the gypsum core tends to shrink as the crystalized water vaporizes and the gypsum dries up. If this shrinkage is not compensated for, the board will disintegrate. Dimensional control and structural integrity can be maintained via the use of anti-shrinkage additives. Anti-shrinkage additives expand in the presence of heat and compensate for the shrinkage that otherwise occurs as a result of the core materials drying out. It is preferred to match the rate of expansion from the additives with the degree of shrinkage in the heated board. This helps maintain the same overall dimensions of the board, and it increases the board's ability to prevent the spread of fire. In sum, anti-shrinkage additives increase fire resistance by maintaining board integrity during a fire.

One known anti-shrinkage additive is vermiculite. Vermiculite is a hydrous, silicate mineral that expands greatly when heated. It is known in the background art to add a relatively small amount of vermiculite to increase the fire resistance of the building board. Vermiculite exfoliates when heated to 300-400° C. and thereby compensates for the shrinkage of the core material. Commercially available building boards typically have about 3% vermiculite by weight. The background art teaches adding vermiculite in amounts up to 7.5% by weight.

An example of the background art is U.S. Pat. No. 2,526,066 to Croce. Croce '006 discloses a fire resistant wallboard panel with a plaster facing. The plaster facing includes 2% by weight of a fibrous material and from 2.5% to 7.5% by weight of minus 28 mesh commercial grading raw or unexpanded vermiculite. Croce '066 discloses the use of vermiculite to increase fire endurance ratings in accordance with ASTM testing designation C19-41. Specifically, the vermiculite increases the fire rating from 35 to 50 minutes to 45 to 51 minutes.

Yet another example of fire resistant wall board is disclosed in U.S. Pat. No. 3,454,456 to Willey. Willey '456 discloses a fire resistant plaster product that includes both chopped glass fibers and unexpanded vermiculite. More specifically, Willey '456 discloses a board containing 0.4% by weight of chopped glass and 6% by weight of unexpanded vermiculite. The result is a gypsum wallboard core with an improved fire rating. Willey '456 states that boards in accordance with its disclosure had a one hour fire rating in accordance with tests established by Underwriters Laboratories.

U.S. Pat. No. 8,323,785 to Yu et al. discloses a lightweight reduced density fire rated gypsum panel. Yu 785 teaches the use of high expansion vermiculite to compensate for weight reduction in a board with a density of 1,950 lbs/msf. Vermiculite is added to the core in amounts of 5 to 10% by weight.

Each of the foregoing references achieves a unique objective; however, all suffer from common drawbacks. In particular, prior efforts have increased fire resistance at the expense of board density. Heavier boards result in increased transportation costs and greatly complicate installation efforts. Moreover, prior efforts have not achieved suitable levels of shrinkage control in order to provide desired levels of fire resistance. The fire resistant building boards of the present disclosure are aimed at overcoming these and other shortcomings present in the background art.

### SUMMARY OF THE INVENTION

Several important advantages are realized by utilizing relatively large amounts of anti-shrinkage materials in a lightweight building board.

For example, it has been discovered that effective fire resistance can be achieved in low density building boards; namely boards with densities less than 1,850 lbs/msf.

The use of lighter weight boards decreases transportation costs and allows the boards to be easily installed and positioned.

A further possible advantage is achieved by increasing fire resistance via large quantities of vermiculite.

In particular, it has been discovered that fire resistance can be dramatically increased via the addition of vermiculite in large amounts; namely amounts exceeding 14% of the weight of stucco within the core.

The ability to achieve effective fire resistance via large amounts of anti-shrinkage materials in low density building boards was unexpected and not predicted by the prior art.

Various embodiments of the invention may have none, some, or all of these advantages. Other technical advantages of the present invention will be readily apparent to one skilled in the art.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a table of a preferred board formulation in accordance with the present disclosure.

FIG. 2 is a graph of temperature versus time for a board constructed in accordance with the present disclosure.

FIG. 3 is a graph of temperature versus time for a lightweight board of the prior art.

FIG. 4 is a table of various board formulations.

FIG. 5 is a table of various board formulations.

Similar reference characters refer to similar parts throughout the several views of the drawings.

### DETAILED DESCRIPTION OF THE DRAWINGS

The present disclosure relates building boards with increased heat and fire resistance. The disclosed building boards have significantly lower densities while at the same time containing significantly larger amounts of anti-shrinkage materials. Preferred densities are less than approximately 1,850 lbs/msf. Anti-shrinkage additives are preferably added in amounts greater than approximately 14% of the weight of the stucco. The inventors have discovered that beneficial, and heretofore unexpected, levels of fire resistance can be achieved by using increased amounts of anti-shrinkage additives in lower density building boards. Details regarding this discovery are provided hereinafter.

Existing building boards achieve fire resistance through additives distributed in the core of the board. These additives may include materials such as chopped glass fibers and anti-shrinkage materials such as vermiculite. In order to achieve acceptable levels of fire resistance, the building boards have generally employed heavier, denser constructions. Higher density boards are not preferable as they lead to increased transportation costs and complicate installation efforts. Prior attempts at decreasing board density with known levels of anti-shrinkage additives resulted in ineffective fire performance. For example, the present inventors created a 15.6 mm board with a density of 1,750 lbs/msf. Vermiculite constituted 10% of the weight of the stucco within the core. The resulting board failed the test method and criteria in ANSI/UL 263 (UL v450).

The present inventors have discovered that desired levels of heat and fire resistance can be achieved by employing significantly higher percentages of anti-shrinkage materials over what has heretofore been known in the background art. Moreover, the inventors have further discovered that these higher percentages can be utilized in boards with considerably lower densities. Such boards unexpectedly surpassed the 1 hour target specified in ANSI/UL 263 (UL v450). One representative, but non-limiting, formulation is detailed in Table 1. This table lists the components of a board constructed in accordance with the present disclosure. The disclosed board was a 15.6 mm board, but it can be readily used in other board configurations.

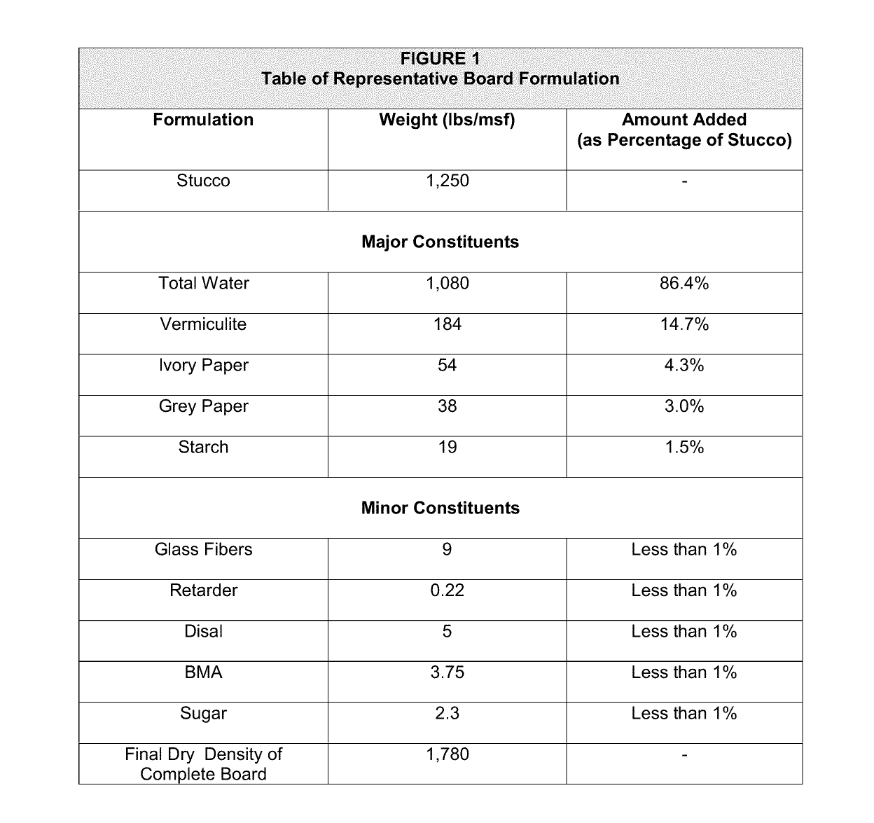

As noted in FIG. 1, the board formulation includes a stucco core as well as various major and minor constituents. The density of the core is preferably achieved by mixing 1,250 lbs/msf of stucco with 1,080 lbs/msf of water. The following minor constituents were included in the core: chopped glass fibers, a retarder, a dispersant (such as disal), a ball mill accelerator (“BMA”), and a sugar. Most of these minor constituents are added in an amount that is less than one percent of the stucco weight. Other minor constituents, such as glass, may be added in greater amounts. In other words, each minor constituent includes a weight that is less than one percent of 1,250 lbs/msf. A number of major constituents were also provided. The largest major constituent was water, added at approximately 86.4% of the stucco weight. For example, for 100 grams of dry stucco, approximately 86.4 grams of water are added. An outer exterior ivory paper face and an interior gray paper face were also provided. These faces constitute 4.3 and 3.0% of the stucco weight respectively. In accordance with the preferred embodiment, the anti-shrinkage material used was a Grade 5 Virginia vermiculite. In accordance with an important aspect of the present invention, the vermiculite was added in an amount constituting approximately 14.7% of the stucco weight. In the specific example of FIG. 1, 184 lbs/msf of Grade 5 vermiculite was uniformly distributed throughout the stucco core. A starch in an amount of 1.5% of the stucco weight was also added. It is also within the scope of the present invention to utilize starch in amounts of up to 4 to 5% of the stucco weight. Furthermore, polymers can be used in lieu of starch to provide the necessary structure to the board. One such polymer is polyvinyl acetate.

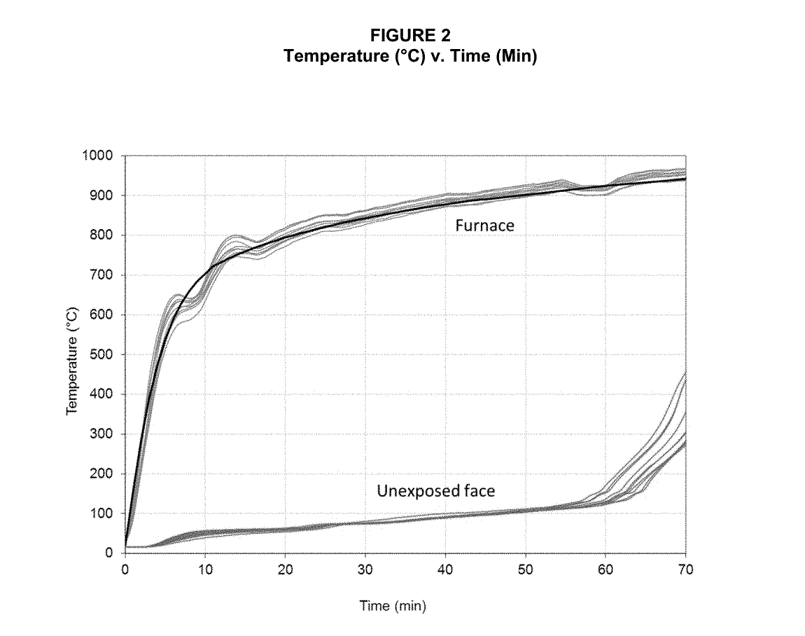

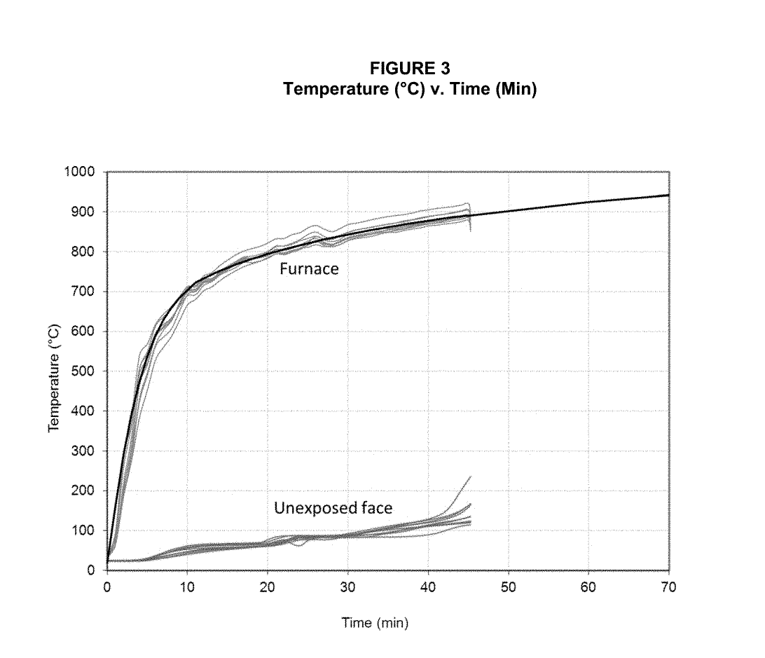

The constituents detailed in FIG. 1 were used to construct a 15.6 mm board having an overall density of 1,780 lbs/msf. This lower density did not result in any structural degradation of the board when heated. To the contrary, the board of FIG. 1 yielded a performance in excess of 1 hour under the ANSI/UL 263 (UL v450) criteria. Increasing the thickness expansion via the addition of large volumes of anti-shrinkage materials did not appreciably decrease the integrity of the board when heated. Notably, the background art would have predicted that vermiculite added in amounts greater than 10% by weight would have unduly altered the dimensions of the core upon being heated. The success of the present formulation is illustrated in FIG. 2. In particular, FIG. 2 is a graph of temperature versus time for a board constructed in accordance with the formulation of FIG. 1. It shows that even as the board is heated to temperatures exceeding 900° Celsius for approximately 1 hour, the temperature of the unexposed board face remains at a temperature of less than 200° Celsius. This is to be compared with a lightweight building board without vermiculite (board weight at 1,710 lbs/msf). This conventional board is analyzed in FIG. 3, which shows that under the same testing conditions, the unexposed face of the board exceeds 200 degrees Celsius in approximately 45 minutes.

FIG. 1 illustrates a preferred board density of 1,780 lbs/msf and vermiculite added in an amount of approximately 14.7% of the stucco weight. However, these values are merely representative and other values fall within the scope of the present disclosure. Specifically, the inventors have found that beneficial results can be achieved with boards having a density ranging from approximately 1,750 lbs/msf to approximately 1,780 lbs/msf. Furthermore, vermiculite in amounts ranging from approximately 11% by weight to approximately 14.7% by weight of the stucco have likewise proven to be effective.

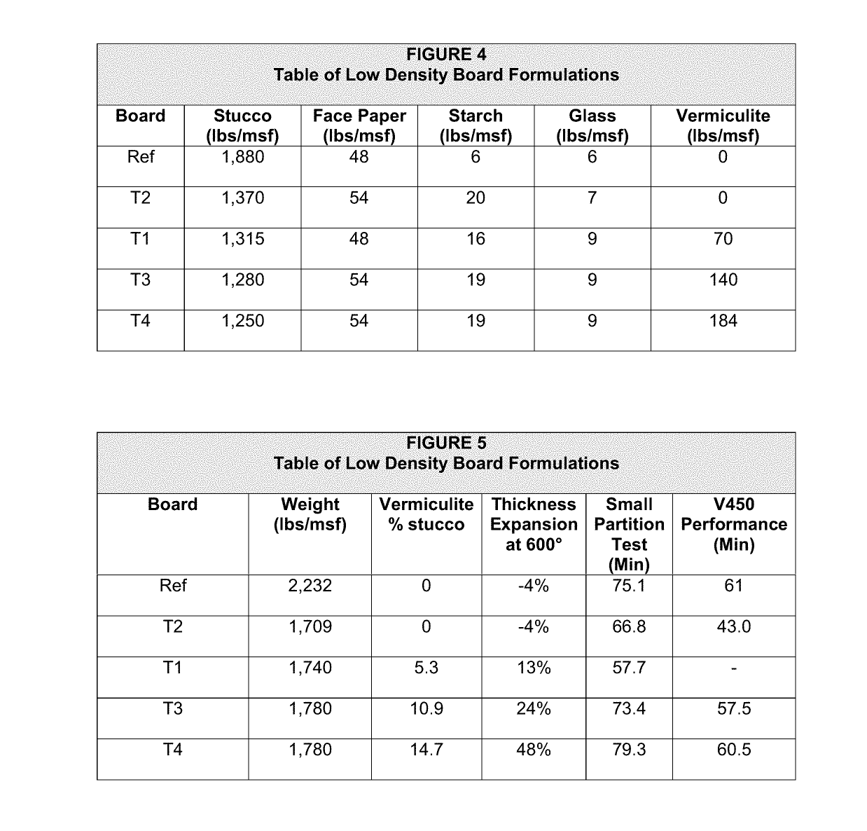

FIGS. 4 and 5 are tables showing the results of various experiments that were carried out in arriving at the preferred board formulation of FIG. 1. As illustrated by the reference board (i.e. “Ref”), a 61 minute fire rating can be achieved in the absence of vermiculite only by increasing the board density to 2,232 lbs/msf. Such boards would be unwieldy and result in excessive transportation costs. Board sample “T2” shows that decreasing board density to 1,709 lbs/msf in the absence of added vermiculite only yields a fire rating of 43.0 min. Smaller amounts of vermiculite were added in board samples “T1” and “T3.” However, these amounts did not yield acceptable levels of fire resistance. Board sample “T4” yielded the desired 60 minute rating by increasing the vermiculite percentage to 14.7 lbs/msf.

Although the present disclosure discloses vermiculite as a preferred anti-shrinkage material, other expanding materials can likewise be used. These expanding materials include expandable graphite, perlite or expandable clay. Furthermore, fiberglass sheets can be used in lieu of paper liners. As used herein, fiberglass sheets may include mats comprising woven or non-woven fibers. Still yet other types of liners can be employed in lieu of paper or fiberglass sheets. The disclosed core can be formed from set stucco, gypsum, or cement. Other dimensions beyond the disclosed 15.6 mm thick board can readily benefit from the disclosed formulations. Boards constructed in accordance with this disclosure can be used for partition systems with steel or wood studs, and for floor/ceiling systems with steel or woods joists. The boards can likewise be used for structural steel encasement systems, ventilation and air extraction duct systems, or shaftwall systems.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

1. A low density composite fire resistant building board comprising:
an exterior face formed from an ivory paper sheet, and an opposing interior face formed from grey paper sheet;
a core comprising stucco, the core extending fully between the interior and exterior faces, the stucco having a weight;
the set core including a plurality of minor constituents, each of the minor constituents comprising less than 1% of the stucco weight, the minor constituents consisting of a retarder, a dispersant, and an accelerator;
the set core including chopped glass fiber, the chopped glass fiber comprising greater than approximately 1.0% of the stucco weight;
a volume of unexpanded Grade 5 vermiculite dispersed throughout the set core, the vermiculite comprising approximately 14% or more of the stucco weight;
the building board having a final dry density that is less than approximately 1,850 lbs/msf.

2. A low density composite fire resistant building board comprising:
opposing sheets;
a set core comprising a core material, the set core extending fully between the opposing paper sheets, the core material having a weight;
a volume of expanding particles dispersed throughout the set core, the expanding particles comprising in excess of approximately 11% or more of the core material weight.

3. The building board as described in claim 2 wherein the expanding particles are Grade 5 vermiculite.

4. The building board as described in claim 2 wherein the set core includes a starch.

5. The building board as described in claim 2 wherein the core includes the following minor constituents: a retarder, a dispersant, and an accelerator.

6. A low density fire resistant building board comprising:
opposing paper sheets;
a set core extending fully between the opposing paper sheets, the set core comprising a material having a weight;
a volume of expanding particles dispersed throughout the set core;
the building board have a density that is less than approximately 1,850 lbs/msf and a fire resistance that exceeds the 1 hour target set forth in the ANSI/UL 263 testing criteria.

7. The building board as described in claim 6 wherein the expanding particles comprise in excess of approximately 11% of the weight of the core material.

8. The building board as described in claim 6 wherein the expanding particles are vermiculite particles that comprise approximately 14% or more of the weight of the core material.

9. The building board as described in claim 6 wherein the expanding particles are Grade 5 vermiculite.

10. The building board as described in claim 4 wherein the starch is present at a level that is greater than 1% of the weight of the core material.

11. The building board as described in claim 4 wherein the starch is present at a level that is between approximately 1-1.5% of the weight of the core material.

12. The building board as described in claim 2 wherein the set core includes glass fiber.

13. The building board as described in claim 2 wherein the set core includes glass fibers present in an amount that is greater than 1% of the weight of the core material.

14. The building board as described in claim 2 wherein the building board has a final dry density that is between approximately 1,750 lbs/msf and 1,850 lbs/msf.
